(19) United States
(12) Patent Application Publication
(10) Pub. No.: US 2009/0092275 A1
(43) Pub. Date: Apr. 9, 2009

(54) MULTIPLE SPEAKERS

(75) Inventor: Ying-Shih HUANG, Taoyuan County (TW)

Correspondence Address: BROWDY AND NEIMARK, P.L.L.C.;624 NINTH STREET, NW, SUITE 300, WASHINGTON, DC, 20001-5303, US

(73) Assignee: Jetvox Acoustic Corp., Taoyuan City (TW)

(21) Appl. No.: 11/934,260

(22) Filed: Nov. 2, 2007

(30) Foreign Application Priority Data
Oct. 9, 2007 (TW) 96137928

(51) Int. Cl. H04R 1/02

(52) U.S. Cl. 381/386

(57) ABSTRACT

A multiple speakers, including: A sound box has a long flat body and a long first voice face at front. Both sides of the first voice face incline separately to from a second voice face. A first speaker unit places inside the sound box including a left speaker and a right speaker that is placed separately at the left end and right end of the first voice face. A second speaker unit places inside the sound box including a left speaker and a right speaker that is placed separately at the left side and right side of the second voice face.

### BACKGROUND OF THE INVENTION

1. Field of the Invention

The present invention relates to a speaker and more particular to a multiple speakers.

2. Description of the Related Art

In the prior art, a multiple speakers like a 5.1 speaker that is popular now consists of: a main speaker unit that has a left speaker and a right speaker in a set and a surround speaker unit that has a left speaker and a right speaker in a set and a heavy-duty bass speaker. In theory, the main speaker unit is placed separately at the both front side of the audience, and the surround speaker unit is placed separately at the both backsides of the audience. The location of the heavy-duty bass speaker is depending on the personal like. However, it is placed at the front side usually in order to have a best sound effect. But, the space of each audience is not allowed to do this furnishing always. So, the most familiar situation is the main speaker unit, the surround speaker unit and the heavy-duty bass speaker placed all at the front of the audience or placed together with the television or the displayer. The room will become disorderliness if the space is not big enough and the cables are chucked all round. The aesthetic feeling will be damaged. Moreover, it is inconvenience and difficulty to place a plurality of speakers with a television or displayer.

### SUMMARY OF THE INVENTION

The primary object of the present invention is to provide a multiple speakers having succinct and harmonious aesthetic feeling.

The second object of the present invention is to provide a multiple speakers that is easy assembly and operation.

To achieve objects of the present invention, a multiple speakers including: A sound box has a long flat body and a long first voice face at front. Both sides of the first voice face incline separately to from a second voice face. A first speaker unit places inside said sound box including a left speaker and a right speaker that is placed separately at the left end and right end of said first voice face. A second speaker unit places inside said sound box including a left speaker and a right speaker that is placed separately at the left side and right side of said second voice face. By this way, the first speaker unit and the second speaker unit connect correspondingly with the main source and surround source to form a single sound box with multiple. The cut face at the front not only has the aesthetic feeling but also good for sound effects. The top of the long flat body is a space for the television or displayer to set and makes all these audio equipments as an integral whole. Present invention shows succinct and harmonious aesthetic feeling and is also convenient to set up or to move.

### BRIEF DESCRIPTION OF THE DRAWINGS

FIG. 1 is a perspectively view of present invention;

FIG. 2 is a back view of present invention;

FIG. 3 is a bottom view of the present invention;

FIG. 4 is a left side view of present invention;

FIG. 5 is a section view from the horizontal direction of present invention.

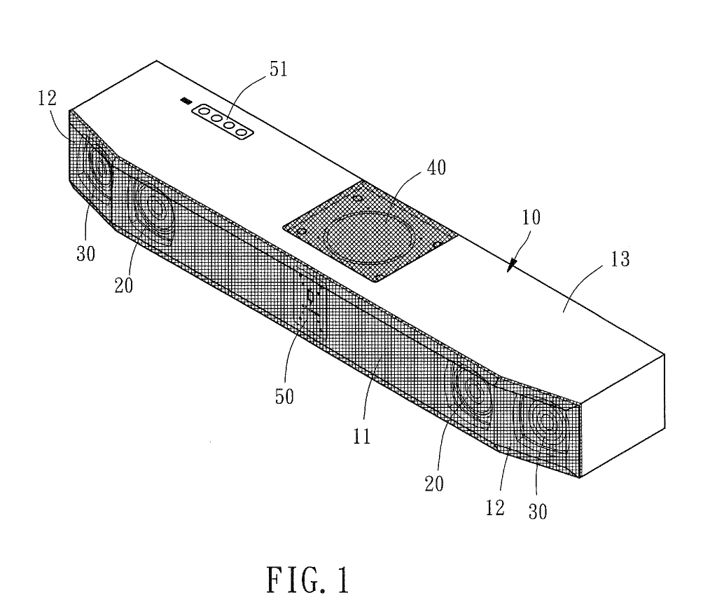

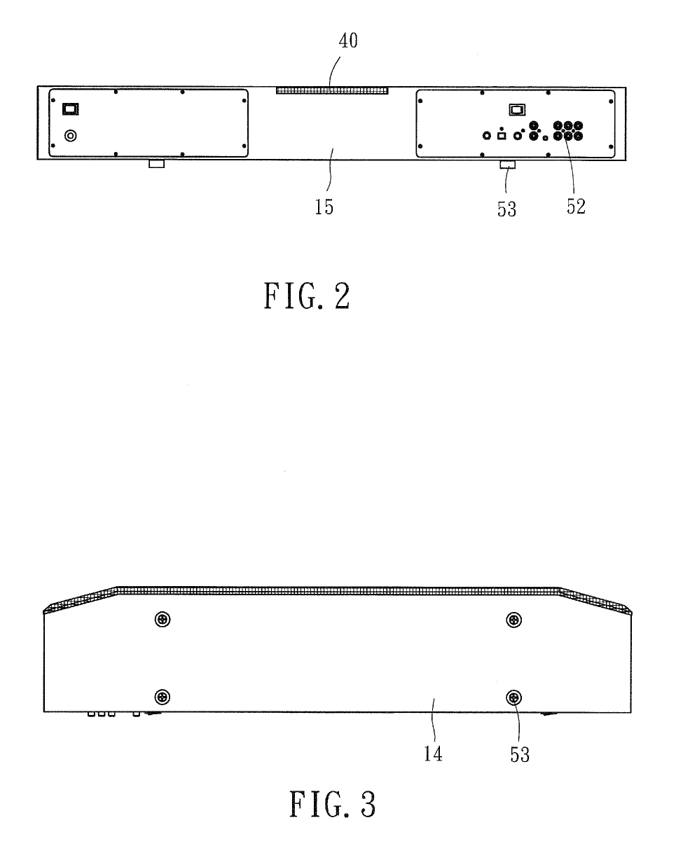

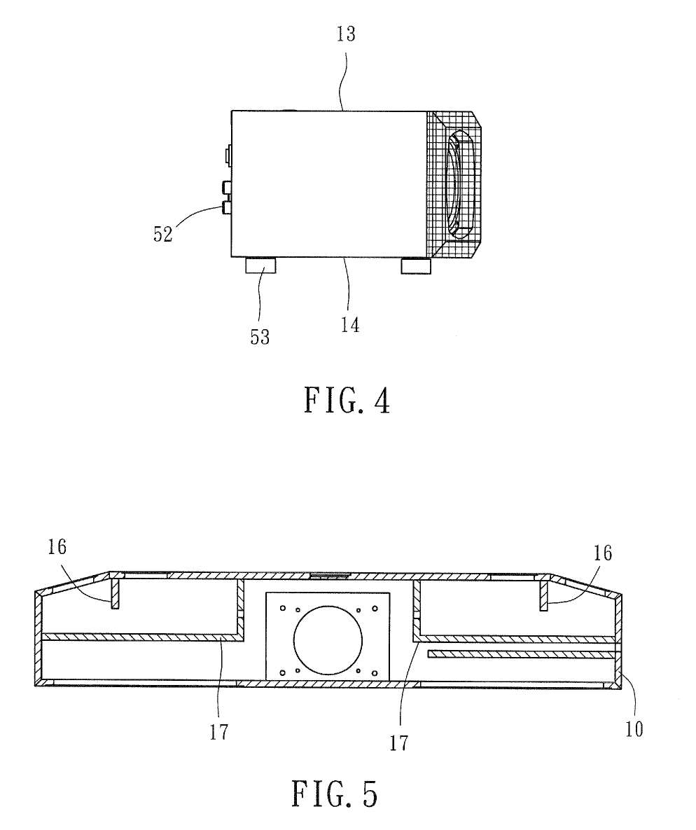

### DETAILED DESCRIPTION OF THE INVENTION

Referring figurations, a multiple speakers of present invention, including:

A sound box 10 has a long flat body. Both ends of the front are cut to from a long first voice face 11 at the middle. Both sides of the first voice face 11 incline separately to from a second voice face 12. In present invention, the included angle between said first voice face 11 and said second voice face 12 can be 8 to 45 degrees. The included angle is 15 degrees in this embodiment.

A first speaker unit 20 places inside said sound box 10 including a left speaker and a right speaker that is placed separately at the left end and right end of said first voice face 11.

A second speaker unit 30 places inside said sound box 10 including a left speaker and a right speaker that is placed separately at the left side and night side of said second voice face 12.

A third speaker unit 40, which is a heavy-duty bass speaker, places inside said sound box 11 between the left speaker and the right speaker of said first speaker unit 20. The output direction of said heavy-duty bass speaker can face to the first voice face 11 or the top 13 or the bottom 14 of said sound box. The output direction faces to the top 13 of said sound box in this embodiment.

The first speaker unit connects with the main source. The second speaker unit connects with the surround source. By the way, present invention forms a multiple (5.1 channels) sound effects. Besides, all these structures from in one sound box 10. The sound box 10 of present invention is indeed an innovative design with succinct and harmonious aesthetic feeling and also eliminates the connection obsession.

There is a display 50 that shows the volume and/or the format of sound effect (like classic music or rock-and-roll or others) placed at the middle of said first voice face 11 in this embodiment. There is a button set 51 provided at the side on the top 13 to control the power and the volume. Of course, a remote control is also provided in present invention (not shown in FIG.).

There is a plurality of connectors 52 provided at the back 15 of said sound box 10 to connect with sound source.

There are four stands 53 provided on the bottom 14 of said sound box 10 to keep the sound box staying away from the support surface.

Referring to FIG. 5, inside said sound box 10, there is a partition 16 placed between said first voice face 11 and said second voice face 12 to separate the speaker of first speaker unit 20 and the speaker of second speaker unit 30. Moreover, left and right speaker of said first speaker unit 20 and said second speak unit 30 can be separated by two partition 17, so, said third speaker unit 40 has a larger independent sound room.

The sound box of present invention sets in horizontal direction and places the main speaker, surround speaker and heavy-duty bass speaker therein. The cut face at both ends of said sound box form a 15 degrees outward voice face and this will make said surround sound has a better effect. The whole shape shows succinct and harmonious aesthetic feeling and also shows high style of audio feeling.

What is claimed is:

1. A multiple speakers, including:
a sound box having a long flat body and a long first voice face at the middle, both sides of the first voice face incline separately to from a second voice face;
a first speaker unit placing inside said sound box including a left speaker and a right speaker that is placed separately at the left end and right end of said first voice face;
a second speaker unit placing inside said sound box including a left speaker and a right speaker that is placed separately at the left side and right side of said second voice face.

2. The speaker as claimed in claim 1, wherein the cut face at both front ends of said sound box forms the second voice face.

3. The speaker as claimed in claim 2, wherein the included angle between the first voice face and the second voice face is 8 to 45 degrees.

4. The speaker as claimed in claim 3, wherein the sound box has a third speaker unit therein.

5. The speaker as claimed in claim 4, wherein the third speaker unit is a heavy-duty bass speaker that is placed between the left speaker and the right speaker of the first speaker unit.

6. The speaker as claimed in claim 5, wherein the output direction of the third speaker unit faces to the top of the sound box.

7. The speaker as claimed in claim 1, wherein the first speaker unit is main sound speaker and the second speaker unit is surround speaker.

8. The speaker as claimed in claim 1, wherein a display is provided at the middle of the first voice face.

9. The speaker as claimed in claim 1, wherein a partition is placed between said first voice face and said second voice face to separate the speaker of first speaker unit and the speaker of second speaker unit.

10. The speaker as claimed in claim 4, wherein a partition is placed inside the sound box to separate the third speaker unit isolatable.
